(19) United States
(12) Patent Application Publication
(10) Pub. No.: US 2013/0338870 A1
(43) Pub. Date: Dec. 19, 2013

(54) SYSTEM AND METHOD FOR PERFORMING DIAGNOSTICS OF AN ACTIVE GRILLE SHUTTER SYSTEM

(71) Applicants: David G. Farmer, Plymouth, MI (US); Ankur Jaiswal, Auburn Hills, MI (US)

(72) Inventors: David G. Farmer, Plymouth, MI (US); Ankur Jaiswal, Auburn Hills, MI (US)

(73) Assignee: CHRYSLER GROUP LLC, Auburn Hills, MI (US)

(21) Appl. No.: 13/524,676

(22) Filed: Jun. 15, 2012

(51) Int. Cl. G06F 7/00

(52) U.S. Cl. 701/29.2; 701/34.4

(57) ABSTRACT

A system and method for diagnosing a mechanical failure in an active grille shutter (AGS) system of a vehicle. The method includes receiving at least one mechanical fault condition signal, each of the at least one mechanical fault condition signals being indicative of whether a particular mechanical fault condition was detected in the AGS system. The method also includes receiving a temperature signal indicating a temperature at a location proximate to a grille shutter of the AGS and determining whether to perform an extended diagnostic based on the at least one mechanical fault condition signal and the temperature signal.

### FIELD

The present disclosure relates to a system and method for performing diagnostics of an active grille shutter system of a vehicle.

### BACKGROUND

A vehicle grille shutter is located at the front of a vehicle and is configured to allow air to flow through the grille shutter to cool the engine block of the vehicle. Increasingly, vehicle grille shutters are becoming automated, such that depending on the state of the vehicle, the flaps of the grille shutter can be open or closed. These grille shutters may be referred to as active grille shutter systems (“AGS systems”). For example, when the vehicle is traveling at higher speeds the flaps can be partially closed or fully closed to increase the aerodynamics of the vehicle. When the vehicle is moving at lower speeds or decelerating, the flaps can be opened to increase the airflow in the engine block. Similarly, decisions such as whether to open and close the flaps can be made based upon the temperature of the engine or the temperature of the coolant.

As should be appreciated, objects may become lodged between the flaps of the grille shutter, thereby obstructing the motion of the flaps. In these scenarios, the motor which opens and closes the grille shutter may continuously attempt to open or shut the flaps, which may ultimately damage the motor. As should be appreciated, however, as time lapses the condition which is obstructing the flap may be resolved, as the object may become dislodged or otherwise removed. Furthermore, links which connect a motor of the AGS to the flaps of the AGS may break or separate from one of the flaps or the motor. In these scenarios, the motor may continue to rotate without effecting the positioning of the flaps, which may also damage the motor.

### SUMMARY

According to some embodiments of the disclosure, a method for diagnosing a mechanical failure in an active grille shutter (AGS) system of a vehicle is disclosed. The method includes receiving, at an on-board diagnostic module, at least one mechanical fault condition signal, each of the at least one mechanical fault condition signals being indicative of whether a particular mechanical fault condition was detected in the AGS system. The method also includes receiving, at the on-board diagnostic module, a temperature signal indicating a temperature at a location proximate to a grille shutter of the AGS, and determining whether to perform an extended diagnostic based on the at least one mechanical fault condition signal and the temperature signal.

According to some embodiments of the present disclosure, a system for diagnosing a mechanical failure in an active grille shutter (AGS) system of a vehicle is disclosed. The system includes an AGS control module that monitors at least one mechanical condition of the AGS system and that generates at least one mechanical fault condition signal being indicative of the mechanical condition of the AGS system and a temperature sensor that generates a temperature signal indicating a temperature at a location proximate to a grille shutter of the AGS. The system further includes an on-board diagnostic module configured to receive the at least one mechanical fault condition signal and the temperature signal and determine whether to perform an extended diagnostic based on the at least one mechanical fault condition signal and the temperature signal.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a drawing illustrating a front view of a vehicle having an active grille shutter system (“AGS system”) according to some embodiments of the present disclosure;

FIGS. 2A and 2B are drawings illustrating examples of mechanical fault conditions that can be detected by the AGS system of FIG. 1 according to some embodiments of the present disclosure;

FIG. 3 is a block diagram illustrating example components of the AGS system of FIG. 1 and an engine control module according to some embodiments of the present disclosure;

FIG. 4 is a flow chart illustrating an example method that can be performed to determine whether to perform an extended diagnostic according to some embodiments of the present disclosure; and

FIG. 5 is a flow chart illustrating an example method for performing the extended diagnostic according to some embodiments of the present disclosure.

### DETAILED DESCRIPTION

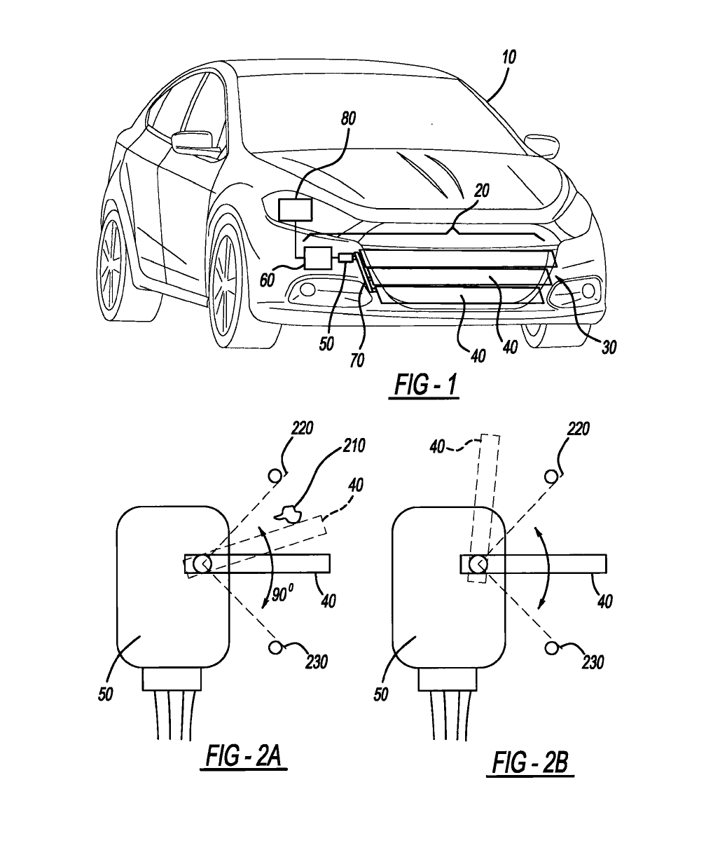

FIG. 1 illustrates a vehicle 10 with an active grille shutter system 20 (“AGS system 20”). In an illustrative example, the AGS system 20 includes a grille shutter 30 having a plurality of flaps 40, a motor 50, one or more links 70 that connect the motor 50 to the plurality of grille shutter 30, and an AGS control module 60 that controls the motor 50. Furthermore, in the illustrated embodiment, the AGS control module 60 is in communication with an engine control module 80 of the vehicle 10.

In an example embodiment, the AGS control module 60 is configured to receive instructions from an engine control module 80 indicating an amount by which to open or close the flaps 40 of the grille shutter 30. The instruction can include a position to which the flaps 40 of the grille shutter 30 are to be moved or an amount that the flaps 40 are to be moved or rotated. The AGS control module 60 provides a command to the motor 50 indicating an amount by which to open or close the flaps 40 of the grille shutter 30. In response to the command signal, the motor 50 drives the one or more links 70 to increase or decrease the opening of the grille shutter 30 by the amount indicated in the command. As should be appreciated, the motor 50 may be an actuator. In some embodiments, the motor is an electric motor.

The engine control module 80 is configured to determine the position to which the flaps 40 are to be moved based on one or more parameters. For example, the engine control module 80 can receive one or more of the following parameter values: a current position of the flaps 40, a speed of the vehicle 10, an acceleration of the vehicle 10, an ambient temperature at the grille shutter 30, a temperature of the engine of the vehicle 10, and a coolant temperature indicating a temperature of the coolant of the vehicle. The foregoing list of parameter values is exemplary only and not intended to be limiting. Based on the received parameter values, the engine control module 80 can determine a position to which the flaps 40 are to be moved. It should be appreciated that the engine control module 80 receives parameter values from any suitable source, e.g., vehicle components, including the AGS control module 60.

In some embodiments, the AGS control module 60 maintains a current position of the flaps 40 and provides the current position of the flaps 40 to the engine control module 80. The AGS control module 60 can determine the position of the flaps 40 in any suitable manner. For example, in some embodiments, the motor 50 is a stepper motor. In these embodiments, the angular positions of the flaps 40 can be determined by dividing the number of steps incremented by motor 50 divided by the total number of steps that the motor 50 can increment. The result of the calculation is a percentage indicating an angle of the flaps 40 with respect to one of the fully open position and the fully closed position. For example, if the motor 50 can increment the flaps 40 to nine different positions starting from the fully closed position, e.g., zero degrees, and ending at the fully open position, e.g., ninety degrees, the position of the flaps 40 can be determined by the number of steps incremented by the motor 50 from the fully closed position divided by nine. The resultant percentage can be multiplied by ninety degrees to determine the angular position of the flaps 40. It should be appreciated that any other suitable technique for determining the position of the flaps 40 may be implemented as well.

Based on the determined position of the flaps 40 and the current position of the flaps 40, the engine control module 80 determines whether the position of the flaps 40 needs to be adjusted, and if so, an amount by which to increase or decrease the opening of the grille shutter 30. Once the engine control module 80 determines the amount by which to increase or decrease the opening of the grille shutter 30, the engine control module 80 provides the amount to increase or decrease the opening of the grille shutter 30 to the AGS control module 60 and the AGS control module 60 instructs the motor 50 to adjust the position of the flaps 40 in accordance with the amount.

As should be appreciated, a mechanical fault condition may materialize with respect to one or more components of the AGS system 20. A mechanical fault condition can be an abnormal condition that causes one or more of the mechanical components of the AGS system 20 to malfunction. Thus, in the illustrative embodiment, the AGS control module 60 is configured to detect mechanical fault conditions within the AGS system 20 and the engine control module 80 is configured to determine whether the mechanical faults have resulted in a mechanical failure. A mechanical failure can be a mechanical fault which after a predetermined amount of time is not resolved or unable to be resolved.

FIGS. 2A and 2B illustrate examples of different types of mechanical fault conditions. It should be appreciated that the mechanical fault conditions depicted in FIGS. 2A and 2B are provided for example only and are not intended to be limiting.

FIG. 2A illustrates an example of a “mechanical stuck” fault condition. A mechanical stuck fault condition is a condition where one or more of the mechanical components of the AGS system 20, e.g., link 70 (FIG. 1) or flap 40, cannot be moved by the motor 50 to at least one of the fully open position 220 and the fully closed position 230. In the illustrated example, an object 210 is preventing the flap 40 from moving to the open position 220. In some embodiments, the range of motion of the flap 40 is 90 degrees. If the range of motion of flap 40 is constrained to less than 90 degrees, the motor 50 may continue to unsuccessfully attempt to move the flap 40. When the range of motion of one or more of the flaps 40 is constrained, the AGS control module 60 generates a “mechanical stuck” fault condition signal, which is a signal indicating a mechanical fault. In some embodiments, when the AGS control module 60 determines a “mechanical stuck” fault condition, the AGS control module 60 provides the “mechanical stuck” fault condition signal to the engine control module 80.

FIG. 2B illustrates an example of a “mechanical broke” fault condition. A “mechanical broke” fault condition is a condition where one or more of the components, e.g., link 70 (FIG. 1) or flap 40, is broken or no longer connected to the other components, such that when the motor 50 is opening or closing the grille shutter 30, the motor 50 rotates the flap 40 past the fully open position 220 or the fully closed position 230. During a calibration sequence, the AGS control module 60 can command the motor to open to the “full open” position or the “full closed” position. If the motor 50 is able to rotate past the “full open” position or the “full closed” position, e.g. more than 90 or −90 degrees, the AGS control module 60 determines a “mechanical broke” fault condition and generates a “mechanical broke” fault condition signal. The AGS control module 60 provides the “mechanical broke” fault condition signal to the engine control module 80. For purposes of explanation, the “mechanical broke” fault condition signal and the “mechanical stuck” fault condition signal are collectively referred to as mechanical fault condition signals.

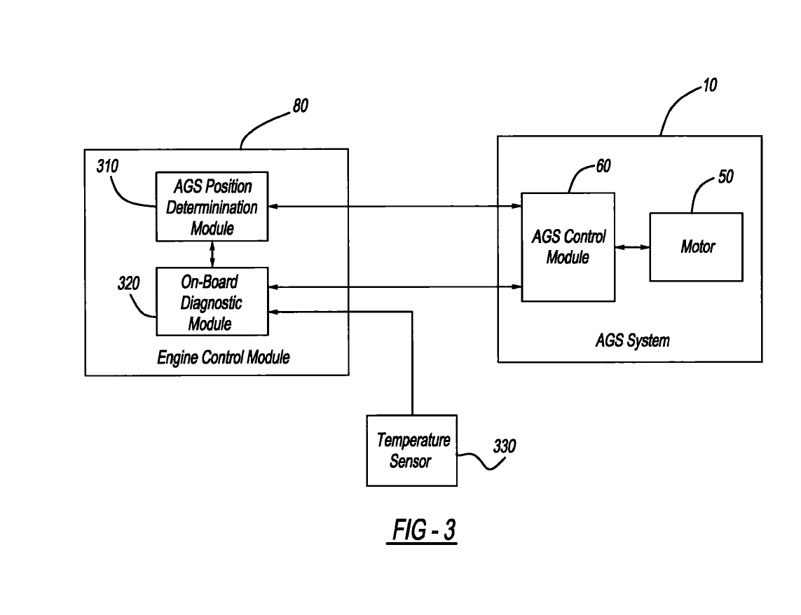

Referring now to FIG. 3, examples components of the engine control module 80 and the AGS system 20 are shown in greater detail. In the illustrative example, the engine control module 80 includes an AGS position determination module 310 and an on-board diagnostics module 320 (“OBD module 320”). The AGS system 20 includes the AGS control module 60 and the motor 50 which are configured as described above. Also shown in FIG. 3 is a temperature sensor 330.

In the illustrated example, the temperature sensor 330 is implemented as an independent component. It should be appreciated that in some embodiments, the temperature sensor 330 may be integrated as a component of the AGS system 20 or the engine control module 80. Furthermore, more than one temperature sensor 330 may be integrated within the vehicle 10. In the illustrative embodiment, the temperature sensor 330 is any suitable sensor that outputs a temperature signal indicating an ambient temperature corresponding to the vehicle 10. It should be appreciated that the temperature sensor 330 may be located proximate to the grille shutter 30. In the illustrated example, the temperature signal is provided to the OBD module 320. It should be appreciated that the temperature signal may also be provided to the AGS position determination module 310, if the AGS position determination module 310 utilizes an ambient temperature to determine a position of the flaps 40. Furthermore, while the temperature signal is described as an ambient temperature, the temperature sensor 330 may output a temperature signal indicative of a different temperature corresponding to the vehicle 10.

In the illustrative embodiment, the AGS position determination module 310 determines a position of the flaps 40 of the grille shutter 30, as was discussed above. The AGS position determination module 310 receives the current position of the flaps 40 from the AGS control module 60 and other parameter values from various sources, e.g., a speed from speedometer, and determines whether the position of the flaps 40 needs to be adjusted, and if so, an amount that that the flaps 40 are to be moved. It should be appreciated that the AGS position determination module 310 can implement any suitable algorithm for determining the position of the flaps 40 and can utilize any suitable parameter values. Furthermore, in some embodiments, the AGS position determination module 310 may be implemented as part of the AGS system 20 rather than as part of the engine control module 80.

In the illustrative embodiment, the OBD module 320 is configured to perform diagnostics relating to one or more systems of the vehicle 10, including the AGS system 20. With respect to the AGS system 20, the OBD module 320 monitors the condition of the AGS system 20 and determines whether the AGS system 20 has mechanically failed. In an exemplary embodiment, the OBD module 320 receives mechanical fault condition signals from the AGS control module 60 and a temperature signal from the temperature sensor 330 and determines whether to perform an extended diagnostic based on the mechanical fault condition signal and the temperature signal. In these embodiments, the OBD module 320 receives the mechanical fault condition signal, i.e., the “mechanical stuck” fault condition signal and/or the “mechanical broke” fault condition signal, and determines whether either of the mechanical fault condition signals indicates that a mechanical fault condition exists with respect to one of the components of the AGS system 20. If a fault condition exists, the OBD module 320 compares the temperature indicated by the temperature signal to a temperature threshold, e.g., zero degrees Celsius. If the temperature is above the temperature threshold, the OBD module 320 performs the extended diagnostic. If the temperature is below the temperature threshold, the OBD module 320 provides a deactivation signal to the AGS position determination module 310 and/or the AGS control module 60 indicating that the AGS system 20 is to be deactivated. In some embodiments, the AGS system 20 is deactivated until the extended diagnostic is performed, i.e., until the temperature indicated by the temperature signal exceeds the temperature threshold.

In the illustrative embodiment, the extended diagnostic is a diagnostic that monitors the mechanical fault condition signals over a period of time to determine whether the mechanical fault condition has been resolved. For instance, if a “mechanical stuck” fault condition is caused by ice or snow being tightly packed between the flaps 40 of the grille shutter 30, the ice or snow may melt thereby resolving the “mechanical stuck” fault condition. Thus, the OBD module 320 receives the mechanical fault condition signals and determines whether the mechanical fault conditions signals indicate a mechanical fault condition. When one of the mechanical fault condition signals indicates a mechanical fault condition, the OBD module 320 increments a counter that maintains a value indicating a number of consecutive mechanical faults detected by the OBD module 320. For purposes of explanation, the counter described above is referred to as the “unsuccessful counter.” Further, when one of the mechanical fault condition signals indicates a mechanical fault condition, the OBD module 320 waits a first predetermined amount of time, e.g., twenty seconds, before repeating the diagnostic. After waiting for the first predetermined amount of time, the OBD module 320 receives the mechanical fault condition signals and repeats the foregoing steps. Once the value of the unsuccessful counter reaches a first predetermined number N, e.g., N=three, the OBD module 320 waits a second predetermined amount of time, e.g., five minutes, before monitoring the mechanical fault condition signals again. If the value of the unsuccessful counter reaches a mechanical failure threshold, e.g., 5, the OBD module 320 determines that there is a mechanical failure associated with the AGS system 20 and deactivates the AGS system 20. Furthermore, the OBD module 320 may issue a notification indicating that a mechanical failure has been detected in the AGS system 20. If, however, during any of the iterations described above, the mechanical fault condition signals are received and do not indicate a mechanical fault condition, the OBD module 320 resets the unsuccessful counter. Furthermore, if the AGS system 20 had been deactivated, the OBD module 320 can provide an activation signal to the AGS position determination module 310 and/or the AGS control module 60. In some embodiments, the OBD module 320 increments a second counter, referred to as a “successful counter,” when no mechanical fault condition is detected or if the mechanical fault condition is resolved.

In the illustrative embodiment, the OBD module 320 is implemented at the engine control module 80. It should be appreciated that in some embodiments OBD module 320 is implemented as part of the AGS system 20. Furthermore, the extended diagnosis described is provided for example only, and other techniques for performing an extended diagnosis are within the scope of the disclosure.

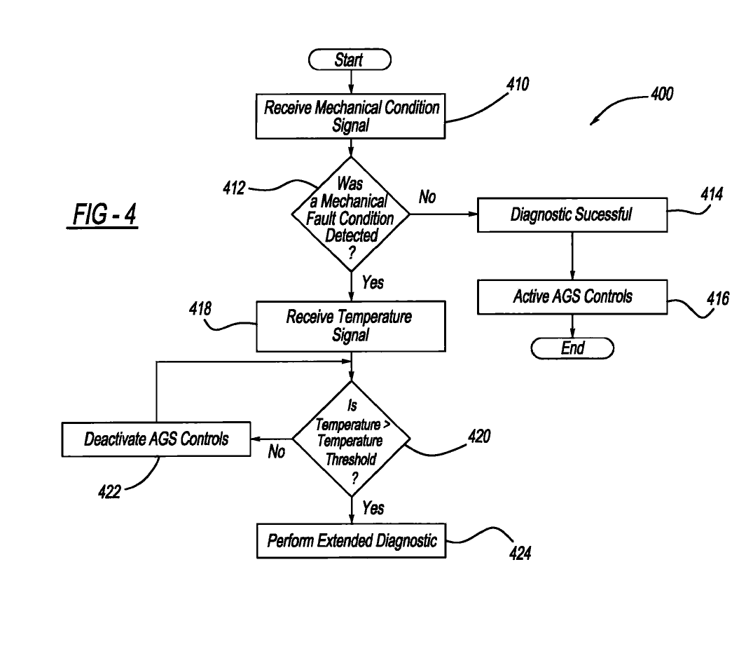

Referring now to FIG. 4, an example method 400 for determining whether to perform an extended diagnostic is illustrated. At 410, the OBD module 320 receives one or more mechanical fault condition signals. As discussed above, the OBD module 320 can receive a “mechanical stuck” fault condition signal and/or a “mechanical broke” fault condition signal. Furthermore, it should be appreciated that in some embodiments the mechanical fault condition signals are continuously provided to the OBD module 320 from the AGS control module 60. In these embodiments, the OBD module 320 is said to “receive” the mechanical fault condition signal when the OBD module 320 processes the mechanical fault condition signal.

At 412, the OBD module 320 determines whether any of the one or more mechanical fault condition signals indicates a mechanical fault condition. It should be appreciated the mechanical fault condition signals can be binary signals that are either ON or OFF. If the mechanical fault condition signal is ON then a mechanical fault condition is said to have been detected, otherwise a mechanical fault condition is not detected. If a mechanical fault condition is not detected, the OBD module 320 determines that the diagnostic is successful, as shown at 414. In some embodiments, the OBD module 320 may increment the successful counter upon determining the diagnostic was successful. At 416, the OBD module 320 provides an activation signal to the AGS position determination module 310 and/or the AGS control module 60. The activation signal can indicate that the diagnostic is complete and the AGS system 20 can operate in a normal state.

If, however, the OBD module 320 determines that a mechanical fault condition exists at 412, the OBD module 320 receives a temperature signal, as shown at 418. As previously discussed, the temperature signal can be indicative of an ambient temperature near the grille shutter 30. At 420, the temperature is compared to a temperature threshold, e.g., zero degrees Celsius. If the temperature does not exceed the temperature threshold, the OBD module 320 can provide a deactivation signal to the AGS position determination module 310 and/or the AGS control module 60, as shown at 422. The OBD module 320 can continue to monitor the temperature signal until the temperature exceeds the temperature threshold. If and when the temperature is above the temperature threshold, the OBD module 320 initiates an extended diagnostic, as shown at 424.

The steps of method 400 are provided for example only. It should be appreciated that not all of the steps are necessary and some of the steps may be combined into a single step. Variations of the method 400 are contemplated and are within the scope of this disclosure.

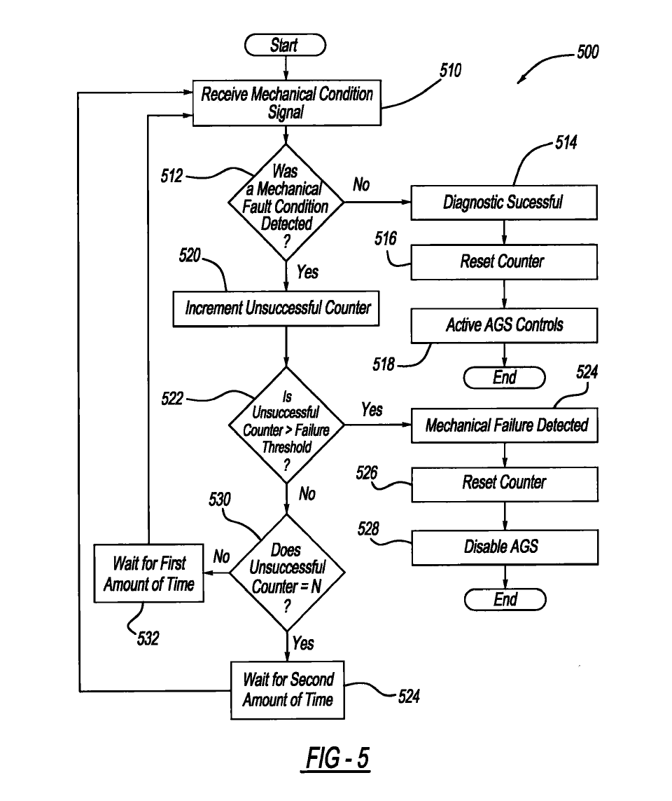

Referring now to FIG. 5, a method 500 for performing an extended diagnostic is illustrated. At 512, the OBD module 320 receives one or more mechanical fault condition signals. At 514, the OBD module 320 determines whether the mechanical fault condition is still detected based on the one or more mechanical fault condition signals. If the mechanical fault condition is no longer detected, the OBD module 320 determines that the diagnostic was successful, as shown at 516. If the OBD module 320 determines that the diagnostic was successful, the unsuccessful counter may be reset, as shown at 518. Additionally, if the OBD module 320 maintains a successful counter, the successful counter may be incremented. Further, an activation signal can be provided to the AGS position determination module 310 and/or the AGS control module 60, as shown at 520.

If a mechanical fault was detected at 514, the OBD module 320 increments the unsuccessful counter, as shown at 522. The OBD module 320 then compares the value of the unsuccessful counter to a failure threshold, as shown at 524. If the value of the unsuccessful counter is greater than the failure threshold, the OBD module 320 determines that a mechanical failure has been detected, as shown at 526. If a mechanical failure is detected, the OBD module 320 resets the unsuccessful counter, as shown at 528, and disables the AGS system 20, as shown at 530. Furthermore, the OBD module 320 may generate a notification that a mechanical failure has been detected in the AGS system 20.

If, however, the counter does not exceed the failure threshold at 524, the OBD module 320 determines whether a predetermined number, N, of iterations have been performed, as shown at 532. In the illustrated method 500, the OBD module 320 compares the value of the unsuccessful counter to the predetermined number N, e.g., 3. If the value of the unsuccessful counter equals the predetermined number, the OBD module 320 waits for a first predetermined amount of time, e.g., twenty seconds, as shown at 534, before returning to step 510. If the value of the unsuccessful counter does not equal the predetermined number, the OBD module 320 waits for a second predetermined amount of time, e.g. 5 minutes, as shown at 536, before returning to step 510.

It should be appreciated that in some embodiments, the first predetermined amount of time is relatively much less than the second predetermined amount of time. As should be appreciated, if N=3, the OBD module 320 can perform three consecutive iterations while waiting twenty seconds between each iteration. If the mechanical fault condition still exists, the OBD module 320 waits five minutes before iterating again.

The steps of method 500 are provided for example only. It should be appreciated that not all of the steps are necessary and some of the steps may be combined into a single step. Variations of the method 500 are contemplated and are within the scope of this disclosure. Furthermore, it should be appreciated that other extended diagnostics are contemplated and are within the scope of the disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

1. A method for diagnosing a mechanical failure in an active grille shutter (AGS) system of a vehicle, the method comprising:
receiving, at an on-board diagnostics module, at least one mechanical fault condition signal, each of the at least one mechanical fault condition signals being indicative of whether a particular mechanical fault condition was detected in the AGS system;
receiving, at the on-board diagnostics module, a temperature signal indicating a temperature at a location proximate to a grille shutter of the AGS; and
determining whether to perform an extended diagnostic based on the at least one mechanical fault condition signal and the temperature signal, including:
determining whether the at least one mechanical fault condition signal indicates that a mechanical fault condition is detected in the AGS system;
comparing the temperature with a temperature threshold only when the mechanical fault condition is detected in the AGS system; and
when the temperature exceeds the temperature threshold, performing the extended diagnostic.

2. (canceled)

3. The method of claim 1, wherein the determining whether to perform the extended diagnostic further comprises continuously monitoring the temperature signal until the temperature exceeds the temperature threshold.

4. The method of claim 3, further comprising, when the temperature does not exceed the temperature threshold, deactivating the AGS system until the temperature exceeds the threshold.

5. The method of claim 1, wherein performing the extended diagnostic comprises:
a) receiving the at least one mechanical fault condition signal;
b) determining whether the mechanical fault condition is still detected based on the at least one mechanical fault condition signal;
c) when the mechanical fault condition is still detected, incrementing a counter value;
d) comparing the counter value to a failure threshold; and
e) when the counter value is greater than the failure threshold, determining that a mechanical failure condition has been detected in the AGS system.

6. The method of claim 5, wherein the extended diagnostic further comprises:
when the counter value is not greater than the failure threshold, comparing the counter value to a predetermined number less than the failure threshold;
when the counter value is not equal to the predetermined number waiting for a first amount of time and repeating steps a)-e) after said first amount of time; and
when the counter value is equal to the predetermined number, waiting for a second amount of time and repeating steps a)-e);
wherein the second amount of time is greater than the first amount of time.

7. The method of claim 5, further comprising deactivating the AGS system when the mechanical failure condition is detected.

8. The method of claim 5, further comprising generating a notification indicative of the mechanical failure condition when the mechanical failure condition is detected.

9. The method of claim 1, wherein the at least one mechanical condition signal includes a mechanical stuck fault condition signal and a mechanical broke fault condition signal, the mechanical stuck fault condition signal being indicative of a component in the AGS system being unable to be moved to at least one of a fully open position and a fully closed position and the mechanical broke fault condition signal being indicative of a component in the AGS system being able to be moved past at least one of the fully open position and the fully closed position.

10. The method of claim 1, wherein the temperature signal is indicative of an ambient temperature at the location proximate to the grille shutter.

11. A system for diagnosing a mechanical failure in an active grille shutter (AGS) system of a vehicle, the system comprising:
an AGS control module that monitors at least one mechanical condition of the AGS system and that generates at least one mechanical fault condition signal being indicative of the mechanical condition of the AGS system;
a temperature sensor that generates a temperature signal indicating a temperature at a location proximate to a grille shutter of the AGS;
an on-board diagnostic module configured to receive the at least one mechanical fault condition signal and the temperature signal and determine whether to perform an extended diagnostic based on the at least one mechanical fault condition signal and the temperature signal, including:
determining whether the at least one mechanical fault condition signal indicates that a mechanical fault condition is detected in the AGS system;
comparing the temperature with a temperature threshold only when the mechanical fault condition is detected in the AGS system; and
when the temperature exceeds the temperature threshold, performing the extended diagnostic.

12. (canceled)

13. The system of claim 11, wherein the on-board diagnostics is further configured to continuously monitor the temperature signal until the temperature exceeds the temperature threshold.

14. The system of claim 13, wherein when the temperature does not exceed the temperature threshold, the on-board diagnostics module deactivates the AGS system until the temperature exceeds the threshold.

15. The system of claim 11, wherein the extended diagnostic comprises:
a) receiving the at least one mechanical fault condition signal;
b) determining whether the mechanical fault condition is still detected based on the at least one mechanical fault condition signal;
c) when the mechanical fault condition is still detected, incrementing a counter value;
d) comparing the counter value to a failure threshold; and
e) when the counter value is greater than the failure threshold, determining that a mechanical failure condition has been detected in the AGS system.

16. The system of claim 15, wherein the extended diagnostic further comprises:
when the counter value is not greater than the failure threshold, comparing the counter value to a predetermined number less than the failure threshold;
when the counter value is not equal to the predetermined number waiting for a first amount of time and repeating steps a)-e) after said first amount of time; and
when the counter value is equal to the predetermined number, waiting for a second amount of time and repeating steps a)-e);
wherein the second amount of time is greater than the first amount of time.

17. The system of claim 15, wherein the on-board diagnostics is further configured to deactivate the AGS system when the mechanical failure condition is detected.

18. The system of claim 15, wherein the on-board diagnostics is further configured to generate a notification indicative of the mechanical failure condition when the mechanical failure condition is detected.

19. The system of claim 11, wherein the at least one mechanical condition signal includes a mechanical stuck fault condition signal and a mechanical broke fault condition signal, the mechanical stuck fault condition signal being indicative of a component in the AGS system being unable to be moved to at least one of a fully open position and a fully closed position and the mechanical broke fault condition signal being indicative of a component in the AGS system being able to be moved past at least one of the fully open position and the fully closed position.

20. The system of claim 11, wherein the temperature sensor monitors an ambient temperature at the location proximate to the grille shutter and the temperature signal is indicative of the ambient temperature.

21. The method of claim 7, wherein the extended diagnostic further comprises incrementing a successful counter value different than the counter value when the mechanical fault condition is no longer detected or is determined to be resolved.

22. The system of claim 16, wherein the extended diagnostic further comprises incrementing a successful counter value different than the counter value when the mechanical fault condition is no longer detected or is determined to be resolved.
